(19) United States
(12) Patent Application Publication
(10) Pub. No.: US 2005/0020282 A1
(43) Pub. Date: Jan. 27, 2005

(54) Virtual satellite position system server

(76) Inventors: Ashutosh Pande, San Jose, CA (US); Steven Chang, San Jose, CA (US); Lionel Garin, Palo Alto, CA (US); Qiyue John Zhang, Cupertino, CA (US)

Correspondence Address: THE ECLIPSE GROUP, 10453 RAINTREE LANE, NORTHRIDGE, CA, 91326, US

(21) Appl. No.: 10/874,775

(22) Filed: Jun. 23, 2004

Related U.S. Application Data
(63) Continuation-in-part of application No. 10/154,138, filed on May 21, 2002.
(60) Provisional application No. 60/292,774, filed on May 21, 2001.

(51) Int. Cl. H04B 7/185

(52) U.S. Cl. 455/456.1; 455/12.1

(57) ABSTRACT

A virtual satellite system server that collects and transmits aiding and assisting data to satellite positioning system enabled device upon an event occurring or upon receipt of a message where the virtual satellite system server may also have a location server that contains location data and determines which virtual satellite system server may respond to another device seeking aiding or assisting information in order for the other device to determine it's position.

### RELATED APPLICATIONS

This application is a continuation-in-part of and claims priority to U.S. patent application Ser. No. 10/154,138, filed on May 21, 2002, entitled “METHOD FOR SYNCHRONIZING A RADIO NETWORK USING END USER RADIO TERMINALS,” by Gregory B. Turetzky et al, that claims priority under 35 U.S.C. § 119(e) of U.S. Provisonal Patent Application No. 60/292,774, filed May 21 2001, entitled “METHOD FOR SYNCHRONIZING A RADIO NETWORK USING END USER RADIO TERMINALS,” by Gregory B. Turetzkey et al, which are incorporated by reference herein.

### BACKGROUND OF THE INVENTION

1. Field of the Invention

This invention relates generally to Satellite Positioning Systems (SATPS) and in particular to position data collection and dissemination with virtual satellite positioning system servers.

2. Related Art

A Satellite Positioning System (SATPS) such as the Global Positioning System (GPS) maintained by the United States Government is based on radio navigation. The GPS system is a satellite based navigation system having a network of 24 satellites, plus on orbit spares, orbiting 11,000 nautical miles above the Earth, in six evenly distributed orbits. Each GPS satellite orbits the Earth every twelve hours.

A prime function of the GPS satellites is to serve as a clock. Each GPS satellite derives its signals from an on board 10.23 MHz Cesium atomic clock. Each GPS satellite transmits a spread spectrum signal with its own individual pseudo noise (PN) code. By transmitting several signals over the same spectrum using distinctly different PN coding sequences the GPS satellites may share the same bandwidth without interfering with each other. The code used in the GPS system is 1023 bits long and is sent at a rate of 1.023 megabits per second, yielding a time mark, sometimes called a “chip” approximately once every micro-second. The sequence repeats once every millisecond and is called the coarse acquisition code (C/A code). Every 20th cycle the code can change phase and is used to encode a 1500 bit long message, which contains “almanac” data for the other GPS satellites.

There are 32 PN codes designated by the GPS authority. Twenty-four of the PN codes belong to current GPS satellites in orbit and the 25th PN code is designated as not being assigned to any GPS satellite. The remaining PN codes are spare codes that may be used in new GPS satellites to replace old or failing units. A GPS receiver may, using the different PN sequences, search the signal spectrum looking for a match. If the GPS receiver finds a match, then it has identified the GPS satellite, which generated that signal.

Ground based GPS receivers use a variant of radio range measurement methodology, called trilateration, in order to determine the position of the ground based GPS receiver. The GPS position determination is different from the radio direction finding (RDF) technology of the past in that the radio beacons are no longer stationary; they are satellites moving through space at a speed of about 1.8 miles per second as they orbit the earth. By being space based, the GPS system can be used to establish the position of virtually any point on Earth using methods such as trilateration.

The trilateration method depends on the GPS receiving unit obtaining a time signal from the GPS satellites. By knowing the actual time and comparing it to the time that is received from the GPS satellites, the receiver can calculate the distance to the GPS satellite. If, for example, the GPS satellite is 12,000 miles from the receiver, then the receiver must be located somewhere on the location sphere defined by the radius of 12,000 miles from that GPS satellite. If the GPS receiver then ascertains the position of a second GPS satellite it can calculate the receiver's location based on a location sphere around the second GPS satellite. The two spheres intersect and form a circle with the GPS receiver being located somewhere within that location circle. By ascertaining the distance to a third GPS satellite the GPS receiver can project a location sphere around the third GPS satellite. The third GPS satellite's location sphere will then intersect the location circle produced by the intersection of the location spheres of the first two GPS satellites at just two points. By determining the location sphere of one more GPS satellite, whose location sphere will intersect one of the two possible location points, the precise position of the GPS receiver is determined to be the location point located on the Earth. The fourth GPS satellite is also used to resolve the clock error in the receiver. As a consequence, the exact time may also be determined, because there is only one time offset that can account for the positions of all the GPS satellites. The trilateration method may yield positional accuracy on the order of 30 meters; however the accuracy of GPS position determination may be degraded due to signal strength and multipath reflections.

As many as 11 GPS satellites may be received by a GPS receiver at one time. In certain environments such as a canyon, some GPS satellites may be blocked out, and the GPS position determining system may depend for position information on GPS satellites that have weaker signal strengths, such as GPS satellites near the horizon. In other cases overhead foliage may reduce the signal strength that is received by the GPS receiver unit. In either case the signal strength may be reduced or totally blocked. In such case, aiding information may be used to aid in location determination.

There are multiple ways of using radio spectrum to communicate. For example in frequency division multiple access (FDMA) systems, the frequency band is divided into a series of frequency slots and different transmitters are allotted different frequency slots. In time division multiple access (TDMA) systems, the time that each transmitter may broadcast is limited to a time slot, such that transmitters transmit their messages one after another, only transmitting during their allotted period. With TDMA, the frequency upon which each transmitter transmits may be a constant frequency or may be continuously changing (frequency hopping).

As previously mentioned, another way of allotting the radio spectrum to multiple users is through the use of code division multiple access (CDMA) also known as spread spectrum. In CDMA all the users transmit on the same frequency band all of the time. Each user has a dedicated code that is used to separate that user's transmission from all others. This code is commonly referred to as a spreading code, because it spreads the information across the band. The code is also commonly referred to as a Pseudo Noise or PN code. In a CDMA transmission, each bit of transmitted data is replaced by that particular user's spreading code if the data to be transmitted is a “1”, and is replaced by the inverse of the spreading, code if the data to be transmitted is “0”.

To decode the transmission at the receiver unit it is necessary to “despread” the code. The despreading process takes the incoming signal and multiplies it by the spreading code chip by chip and sums the result. This process is commonly known as correlation, and it is commonly said that the signal is correlated with the PN code. The result of the despreading process is that the original data may be separated from all the other transmissions, and the original signal may be recovered. A property of the PN codes that are used in CDMA systems is that the presence of one spread spectrum code does not change the result of the decoding of another code. The property that one code does not interfere with the presence of another code is often referred to as orthogonality, and codes, which have this property, are said to be orthogonal. The process of extracting data from a spread spectrum signal is commonly known by many terms such as correlating, decoding, and despreading. Those terms may be used interchangeably herein. The codes used by a spread spectrum system are commonly referred to by a variety of terms including, but not limited to, PN (Pseudo Noise) codes, PRC (Pseudo Random Codes), spreading code, despreading code, and orthogonal code. Those terms may also be used interchangeably herein.

It is because CDMA spreads the data across a broadcast spectrum larger than strictly necessary to transmit data that CDMA is often referred to as spread spectrum. Spread spectrum has a number of benefits. One benefit being that because the data transmitted is spread across the spectrum, spread spectrum can tolerate interference better than some other protocols. Another benefit is that messages can be transmitted with low power and still be decoded, and yet another benefit is that several signals can be received simultaneously with one receiver tuned on the same frequency.

The GPS system uses spread spectrum technology to convey its data to ground units. The use of spread spectrum is especially advantageous in satellite positioning systems. Spread spectrum technology enables GPS receiver units to operate on a single frequency, thus saving the additional electronics that would be needed to switch and tune other bands if multiple frequencies were used. Spread Spectrum also minimizes power consumption requirements of GPS receivers. GPS transmitters for example require 50 watts or less and tolerate substantial interference.

Although the GPS system is available widely, there are conditions that can degrade its performance or block the effectiveness of individual GPS satellite position system receiver units, such as GPS receivers. But while some GPS receivers are less effective in determining their location others may not be blocked and are able to determine their location.

A known approach improving a GPS receiver units' ability to acquire the visible GPS satellites is to use aiding information such as a timing signal provided by a fixed terrestrial network or almanac and ephemeris data stored in a fixed network device. But, GPS receiver units may have problems receiving a signal from the terrestrial network as well as the GPS satellites. Further, the implementation of fixed network solutions require expense equipment being purchased and maintained by network operators. Fixed network solutions are also susceptible to network outages and failures. Often the expansion of network solutions is limited to adding additional hardware to the network at considerable cost.

Previous approaches to increasing the ability of the GPS receiver unit to acquire GPS satellites and determine the location of the GPS receiver unit involved the GPS receiver unit being configured to receive aiding or assigning data from another network, such as a cellular network. But, such approaches are less then optimal due to the number of different types of networks, cost of network infrastructure and problems inherent with outages that may occur within fixed networks.

Therefore, there is a need for methods and systems for improving the ability of GPS receiver units to determine their location that overcomes the disadvantages set forth above and others previously experienced.

### SUMMARY

Systems consistent with the present invention provide a virtual satellite system server that may be located within a wireless device, GPS enabled wireless device, fixed network element, or accessed by a GPS enabled device. The virtual satellite system server may receive, store, and transmit aiding or assisting position data to GPS enabled devices that are unable to receive satellite positioning data from enough GPS satellites to determine a location of the GPS enabled devices or to aid in reducing the time for acquisition GPS satellites.

The virtual satellite system server may be implemented in a wireless device such as, for example, a mobile station, PDA, Bluetooth enabled device. The wireless device having a virtual satellite system server may provide aiding or other information to other virtual satellite system servers or fixed network based location servers. Wireless devices with or without a virtual satellite system server may also receive aiding or assisting information from the virtual satellite system server enabled device.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 illustrates a functional framework of satellite positioning system with a GPS Data Center.

FIG. 2 is a block diagram of the Mobile Station of FIG. 1 with the GPS client that implements a virtual satellite system server.

FIG. 3 is a block diagram inside of the GPS enabled Mobile Station of FIG. 2 having a virtuai satellite system server implementing the functionality of the GPS reference receiver and GPS Data Center.

FIG. 4 illustrates the GPS enabled Mobile Station of FIG. 2 with a virtual satellite server within wireless network receiving information from other wireless devices.

FIG. 5 is a block representation of networks elements being combined in a virtual satellite system server of FIG. 2.

FIG. 6 is a block diagram illustrating the network elements that are implemented in a virtual satellite system server of.

FIG. 7 is a GPS enabled device communicating with another GPS enabled device having a virtual satellite system server of FIG. 2 within a wireless network.

FIG. 8 is a block diagram of a virtual satellite system server of FIG. 6 communicating with a plurality of GPS clients.

### DETAILED DESCRIPTION

Unlike the known approaches previously discussed, a virtual satellite system server enables multiple satellite system servers to be deployed throughout a wireless network, for example a cellular network, Bluetooth network, and 802.11 wireless network. Unlike fixed network GPS reference receiver implementations, a virtual satellite system server enables network operators avoid having to implement expensive fixed GPS reference receivers throughout a network while increasing the reliability of network aiding of GPS enabled wireless devices.

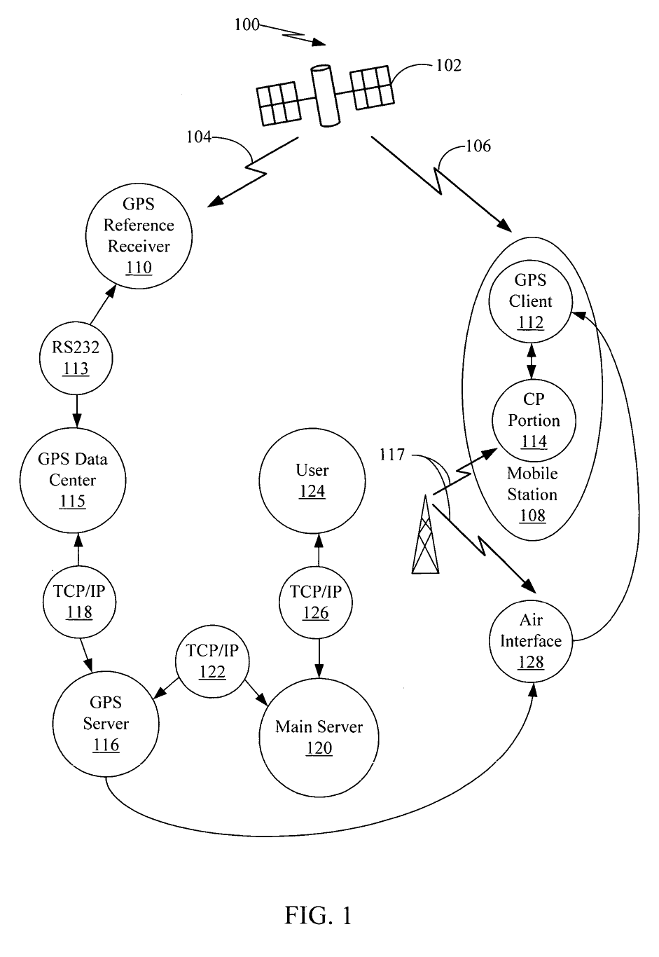

Turning first to FIG. 1, a functional framework of a satellite position system 100 is shown. A plurality of satellites, one of which is shown 102, orbits the Earth in a constellation. An example of such a satellite constellation is the global positioning system (GPS) operated by the United States Government. The satellite 102 communicates 104 and 106 with a GPS enabled device such as Mobile Station 108 and a GPS reference receiver 110. The Mobile Station 108 may have a GPS client 112 and a communication part (call processing portion) 114 that is able to communicate with a communication and or data network 117 such as a cellular, Bluetooth, or 802.11 type wireless networks for example.

The GPS reference receiver 110 collects positioning data from a GPS receiver. The positioning data may include Ephemeris, Almanac, GPS time as well as other GPS data. The GPS reference receiver 110 may be in communication with a GPS Data Center 115 via a communication link such as RS232 link 113 that carries a protocol such as NMEA-108, RTCM 104, and/or propriety message formats. The GPS Data Center 115 stores the positioning data received by the GPS reference receiver 110.

The RS232 link 113 may be transported over a telephone network (Public System Telephone Network) or a dedicated link such as a microwave communication link to give but a few examples. The GPS Data Center 115 may be in communication with a GPS server 116 over a TCP/IP connection 118.

The GPS server 116 may process positioning data received from the GPS reference receiver 110 and stored in the GPS Data Center 115 in order to determine a position. Further, the GPS server 116 may receive positioning data from other devices and determine a position by processing that positioning data. The GPS server 116 would then responds to the other device with the positioning result. The GPS server 116 may communicate with a main server 120 over a TCP/IP link 122.

The main server 120 may also communicate with a user 124 over another TCP/IP link 126. The main server 120 may receive geolocation request from the user 124 and provides a transport mechanism between the GPS server 116 and Mobile Station 108 and ultimately is able to return the geolocation information to the user 124. The user 124 may be an enhanced 911 (E911) server for a public safety answering point (PSAP) or other data services such as, for example, providing locations of nearby restaurants, stores, or entertainment venues. The network elements 110, 115, 116, 120, and 124 are shown as separate network elements In other implementations, the network elements may be combined or relocated within the network.

The GPS server 116 communicates using an over the air-interface 128 with the Mobile Station 108. The Mobile Station 108 may be an electrical device such as, but not limited to, a cellular telephone, Personal Computer (PC), handheld computer, Personal Digital Assistant (PDA), PCS devices, and Bluetooth enabled devices. The air-interface 128 may be, for example, a cellular telecommunication standards such as IS-801, CDMA, TDMA, AMPs, NAMPs, iDEN, or other wireless communication standards such as Bluetooth or Wi-Fi to name but a few. The air-interface 128 may be transmitted over the infrastructure of the network 117, such as a network tower connected to base stations and transport networks such as PSTNs.

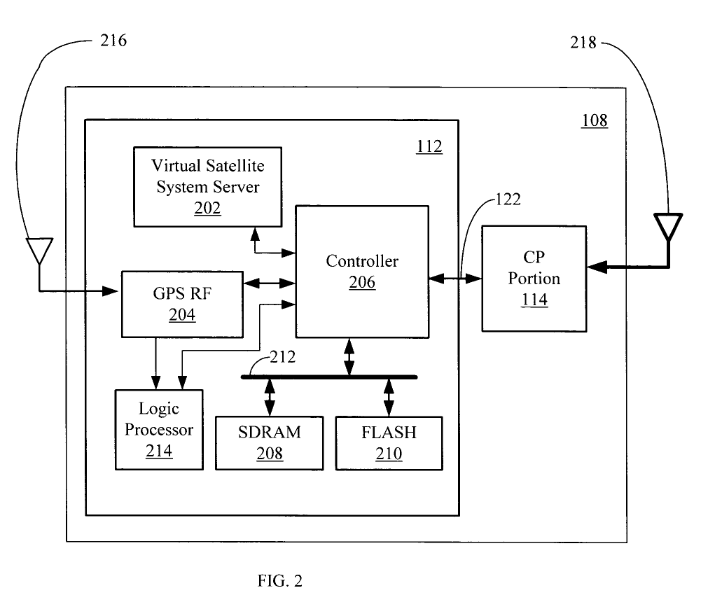

Turning to FIG. 2, a block diagram of the Mobile Station 108 of FIG. 1 with the GPS client 112 that implements a virtual satellite system server (VSSS) 202 is illustrated. The GPS client 112 of the GPS enabled Mobile Station 108 has a GPS RF receiver 204, a controller 206, Synchronous Dynamic Random Access Memory (SDRAM) 208, flash memory 210, bus 212, and a logic processor block 214. The GPS RF receiver 204 receives the ranging signals (spread spectrum signals in the present implementation) via antenna 216. The controller 206 communicates with the virtual satellite system server 202, GPS RF receiver 204 and logic processor block 214.

The controller 206 executes a plurality of instructions stored in memory, i.e. SDRAM 208 and flash memory 210, and acts on the results generated by the logic processor block 214 that processes the received spread spectrum signal. In an alternate implementation, the flash memory 210 may be read-only memory or other types of reprogrammable memory. The logic processor 214 may be an analog-to-digital converter, match filter, correlators or a combination of the previous digital logic devices and other logic devices that aid in the processing of ranging signals, such as GPS spread spectrum signals. The controller 206 accesses the SDRAM 208 and flash memory 210 over bus 212.

The controller 206 may also communicate with a host portion or CP portion 114 that may have a processor or controller in addition to the baseband processor and communicate with a wireless network via antenna 218. The processor or controller processes the I & Q measurements or digital RF from the data network 117 in the CP portion 114. The CP portion 114 may communicate with the controller 206 to receive the I and Q measurements. Or in an alternate implementation, the CP portion 114 may communicate with the GPS RF Receiver 204 and receive digital RF data. The processing portion of the CP portion 114 may have a memory with a plurality of instructions that the processor or controller execute to process the I & Q measurements.

If the controller 206 is not able to determine the location of the GPS enabled Mobile Station 108, then additional augmentation data or aiding data may be employed. Such data may be retrieved from a virtual satellite system server 202. The virtual satellite system server 202 may reside locally in the GPS client 112 or in the CP portion 114. Data that may be contained in the virtual satellite system server 202 includes, but is not limited to almanac, ephemeris, GPS time, and DGPS data. The controller 206 may access aiding or assisting data contained in the virtual satellite system server 202 in order to determine the location of the GPS enabled Mobile Station 108.

Once the location of the GPS enabled Mobile Station 108 is determined, data such as the current almanac, ephemeris, GPS time, and DGPS data may be sent to the virtual satellite system server 202 that may reside in the GPS client 112. Further, periodic updates of the virtual satellite system server 202 may occur at predetermined intervals or upon the occurrence of an event. Examples of an event may include the reception of a token via a wireless network, reception of a broadcast message via a wireless network, upon an expiration of a timer, upon a new satellite signal being received by the GPS RF receiver 204.

The GPS client 112 of the GPS enabled Mobile Station 108 may have different modes, such as autonomous mode, network aided mode, and network centric mode that also may include communicating with virtual satellite system servers. In FIG. 2, the GPS client 112 functions as a sensor with the controller 206 generating raw data, such as I and Q measurement samples, for use by the CP portion 114. In this configuration, more power of the multifunction portion may be used to acquire weaker signals.

The GPS enabled Mobile Station 108 in an active mode may execute a plurality of instructions that operates the GPS client 112 as the sensor function. The sensor function results in the GPS client 112 receiving spread spectrum signals via antenna 216 at GPS RF receiver 204 and the generating raw pseudo range data by the controller 206. The raw pseudo range data is then sent to the CP portion 114 over communication path 122. The processing power of the CP portion 114 may then be used in conjunction with the controller 206 to compute the latitude, longitude, altitude, time, heading, and velocity. The CP portion 114 may simply pass location data to the controller 206, act as a host for the GPS client, or preprocess/process location data. Thus, the added processing power of the CP portion 114 may be employed to aid in location determination. Another advantage of the sensor function is the ability to acquire weaker signals (as low as −162 dbm). The sensor function may have the greatest impact on a device incorporating a GPS client 112, but results in the ability to acquire weaker satellite signals and more quickly lock on to acquired signals.

Although the memory is depicted in FIG. 2 as SDRAM 208 or flash memory 210, one skilled in the art will appreciate that all or part of systems and methods consistent with the present invention may be stored on or read from other machine-readable media, for example, secondary storage devices such as hard disks, floppy disks, and CD-ROMs; a signal received from a network; or other forms of ROM or RAM either currently known or later developed. Further, although specific components of the GPS enabled Mobile Station 108 are described, one skilled in the art will appreciate that a positioning system suitable for use with methods, systems, and articles of manufacture consistent with the present invention may contain additional or different components. For example, the controller 206 may be a microprocessor, microcontroller, application specific integrated circuit (“ASIC”), discrete or a combination of other types of circuits acting as a central processing unit, a specially designed DSP that processes data in blocks of size other than multiples of eight bit. The memory 208 may be RAM, DRAM, EEPROM, or any other type of read/writeable memory.

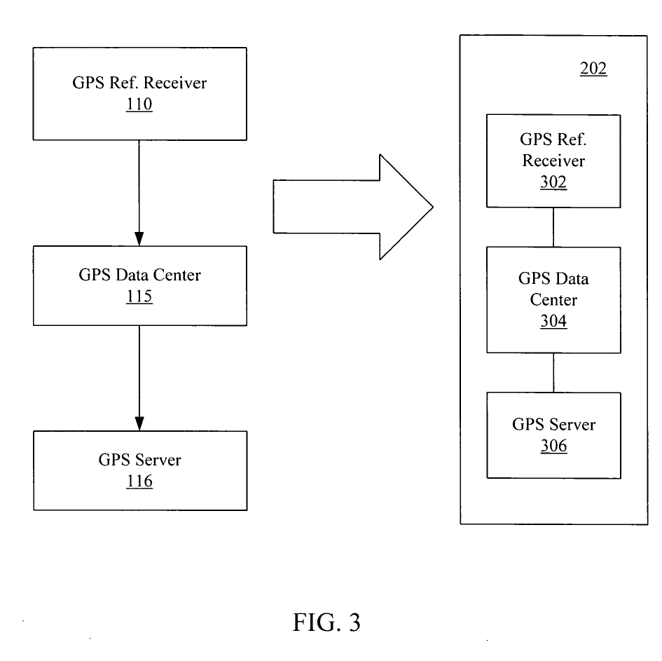

In FIG. 3, a block diagram inside of the GPS enabled Mobile Station 108, FIG. 2 having a virtual satellite system server 202 implementing the functionality of the GPS reference receiver 110, GPS Data Center 115 and GPS Server 116 is shown. The GPS client 112 has a virtual satellite system server 202 that is made up of an internal GPS reference receiver portion 302, a GPS Data Center portion 304 and a GPS server 306 that may be implemented in the Mobile Station 108. The virtual satellite system server 202 may be used as a GPS assistance data source (when navigating) or as a GPS assistance data user (when trying to acquire satellites). Thus, other Mobile Stations having virtual satellite system servers in a common geographic area (referred to as a neighborhood) may provide the GPS assistance data for a given Mobile Stations or the other Mobile Stations having virtual satellite system servers may request assistance when attempting to acquire satellites. The use of the virtual satellite system server 202 saves on the expense of implementing fixed real/physical GPS reference receivers throughout a network.

The Mobile Station 108 may operate in a network aided GPS mode, it may be powered “ON” long enough to collect the totality of all ephemeris and almanac data necessary to provide aiding. The “ON” time may be between 1-10 seconds, ephemeris data collection may require up to approximately 30 seconds and may not be possible if the Mobile Station is in a harsh environment. In other implementations, the aided GPS mode may be powered “ON” long enough to collect and transmit portions of the ephemeris and/or almanac data. The Mobile Station 108 may collect only a fraction of the navigation data or messages (i.e. one word or one subframe at most), and the information may be combined with other pieces of data collected by other Mobile Stations. The positioning data is moved from Mobile Station to Mobile Station or device to device by use of a shuttle message that transports the partial data and is updated by the device that is in current possession of the shuttle message. Once the data is collected, it may be decoded in a Mobile Station or place where sufficient information is not directly available, and where enough information is in the shuttle message.

The positioning data being moved in the shuttle message may be at different levels of processing. The positioning data may be complete, current and valid set of positioning data that may be used for immediate satellite acquisition. The data may also be incomplete raw data at different levels of collection and verification and may pertain to future positioning data. This data may be collected in the background in the shuttle message and substituted to the complete current and validated set of positioning data. Thus, there is a simultaneous benefit from the shuttle message to accelerate the acquisition of GPS satellites while preparing future positioning data in parallel. In other embodiments, the shuttle message may only assemble and provide current, validated set of positioning data.

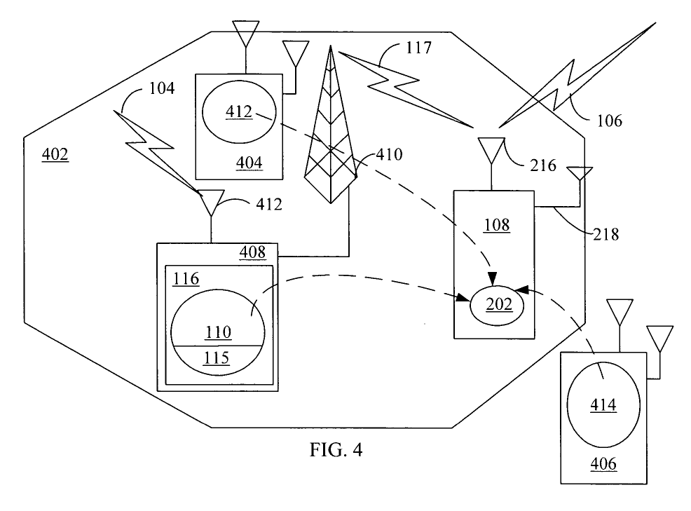

In FIG. 4, the GPS enabled Mobile Station 108 of FIG. 1 with a virtual satellite server 202 within wireless network 402 receiving information from other mobile stations 404 and 406 is illustrated. The other mobile stations may be located within a wireless network, such as mobile station 404 or external to the wireless network 406 as long as communication is possible between mobile stations 108 and 406. Examples of such communication would be mobile stations 108 and 406 communicating using a Bluetooth network rather than the cellular network 402. The wireless network 402 has base station 408 that contain GPS server 116 with a co-located GPS reference receiver 110 and GPS Data Center 115 and is connected to antenna 410 and GPS antenna 412. The other wireless device 404 having a virtual satellite system server 412 is also within wireless network 402. The third device 406 outside of wireless network 402 and also contains a virtual satellite system server 414. The third device 406 may be a Bluetooth enabled wireless device that contains a virtual satellite system server 414.

The additional devices 404 and 406 may communicate with the GPS enabled Mobile Station 108 via the communication link 117 (or over a control channel) established within the network infrastructure of network 402 via base stations that connected with other networks such as the public switch telephone network and/or microwaves. Wireless device 406 is shown as being outside of the wireless network 402 while wireless device 404 is within wireless network 402. The wireless device 108, 406, and Mobile Station 404 are shown as wireless device, but in other implementations may be a wireless device, wired device or transportable wired/wireless device.

If the GPS enabled Mobile Station 108 is unable to determine its location from the GPS signal 110 and possesses a virtual satellite system server 202, such as the GPS reference receiver 302 and GPS Data Center 304 of FIG. 3, the GPS enabled Mobile Station 108, FIG. 4 may request aiding or assisting information from other satellite position system servers in other devices located in the network 402, such as the base station 408 via antenna 410, the wireless device 404, or other wireless device 406. A broadcast message may be sent over a control channel by the GPS enabled Mobile Station 108 that request aiding or assisting information from other devices and the other devices 408, 404 and 406 that have virtual satellite servers systems may then respond. In other embodiments, the responses may be sent over voice or data channels established between the GPS enabled Mobile Station 108 and the other devices 404, 406 and 408. Such communication is shown in FIG. 4 as dashed lines with arrows that terminate at the virtual satellite system server 202.

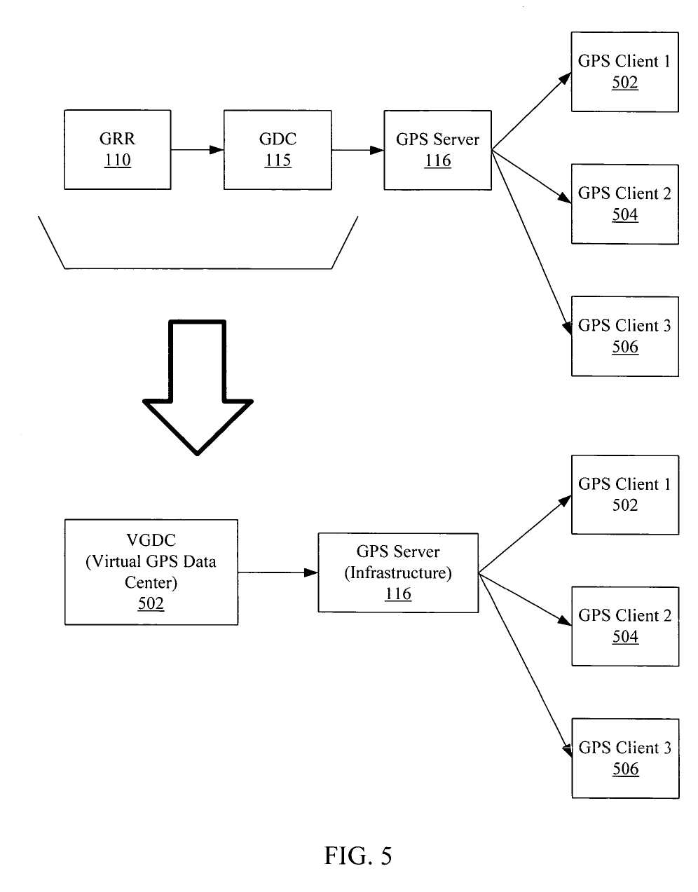

Turning to FIG. 5, a block representation of networks elements 110 and 115 being combined in a virtual GPS Data Center (VGDC) 502. The VGDC 202 communicates with the GPS Server 116. The GPS Server 116 then communicates with GPS clients 502 and additional GPS clients 504 and 506 that may also be present in respective Mobile Stations (not shown). The GPS clients 502 504, and 506 are able to communicate with a GPS server 116 in order to receive aiding or assisting information. Alternatively, the GPS clients 502, 504 and 506 may contain the functionality of a virtual GPS Data Center 508 this is a subset of the virtual satellite server system 202 in a wireless or handheld device GPS Data Center. The virtul GPS Data Center communicates with a GPS server 116 fixed as infrastructure within a network.

The VGDC 508 is able to determine an approximate location, acquire almanac data and ephemeris data and store that information in a virtual GPS Data Center 202. The information contained in the VGDC 508 may be exchanged with the GPS server 116. The information, once acquired by the GPS server 116 is accessible from other GPS clients, such as GPS client 1 502, GPS client 2 504 and GPS client 3 506.

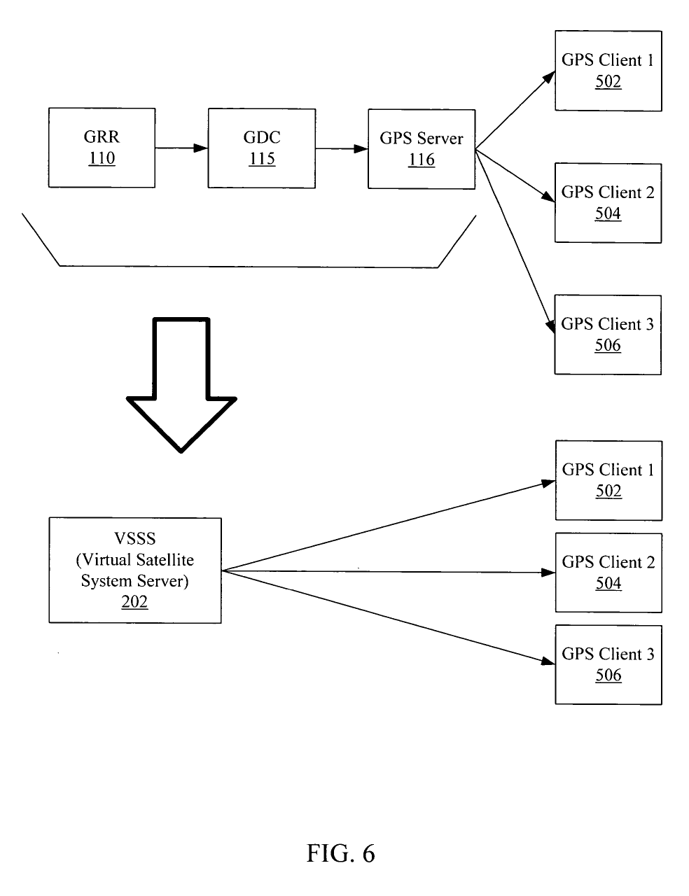

In FIG. 6, a block diagram illustrating the network elements 110, 115 and 116 that are implemented the VSSS 202 is shown. The network elements are shown communicating with GPS clients 502, 504 and 506 with a point-to-point connection. The VSSS combines the functionality of the GPS reference receiver 110, GPS Data Center 115 and the GPS server 116 in the VSSS 202. The combined functionality enables a wireless device, such as Mobile Station 108, to receive and store location data such as almanac data, ephemeris data and location data, in addition to being able to receive such data from other virtual satellite system servers that may be either network based or wireless based. Thus, point-to-point communication between virtual satellite systems servers may be established in order to transfer and share location data. Further, the virtual satellite system server 602 may provide aiding or assisting data to other GPS clients that are only able to request aiding or assisting information from virtual satellite system servers.

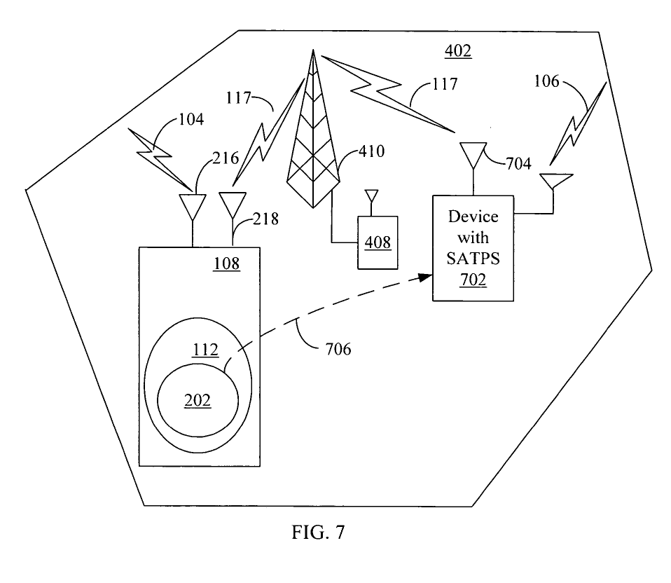

Turning to FIG. 7, a GPS enabled device 702 communicating with a GPS enabled device 108 having a virtual satellite system server 202 within a wireless network 402. The GPS enable device 702 has a satellite position system (SATPS) receiver connected to antenna 216. The GPS enabled device 108 with a virtual satellite system server 202 contained within the GPS client 112 is able to communicate 706 directly with the GPS enabled device 702 via the wireless network 402 using the infrastructure, i.e. base station 408 via antenna 218. The virtual satellite system server 202 in the GPS enabled device 108 provides aiding and/or assisting data to other mobile units. Depending on the virtual satellite system server 202, a GPS server may be implemented in the network or may be part of the virtual satellite system server 202. The virtual position system server 202 may reside in the GPS enabled client 112 or may reside in the call-processing unit 114 of a wireless device such as a cellular telephone. The GPS enabled client 112 having the virtual satellite system server 202 may or may not reside within the same wireless network as the requesting wireless device 702. The wireless network 402 may enable the transmission 117 of the aiding and/or assisting data. It may be accomplished either over a general control channel or in other embodiment over a connection oriented or connectionless session. In yet other wireless systems, the connection may be directly among multiple wireless devices on an IP bearer or via a network feature such as instant messaging.

The virtual satellite system server 202 implements the GPS receiver, GPS Data Center and GPS server that provide GPS satellite information as required for assisting or aiding devices that are attempting to determiner their positions. The virtual satellite system server 202 may be in a network entity such as a base station 408 or other devices. The virtual satellite system server 202 may use the controller of the wireless device to execute a set of instructions that implement the virtual satellite system server 202 or may have a separate controller. The virtual satellite system server 202 may reside in GPS client in handheld PDAs, cellular telephones, and other wireless and non-wireless portable devices.

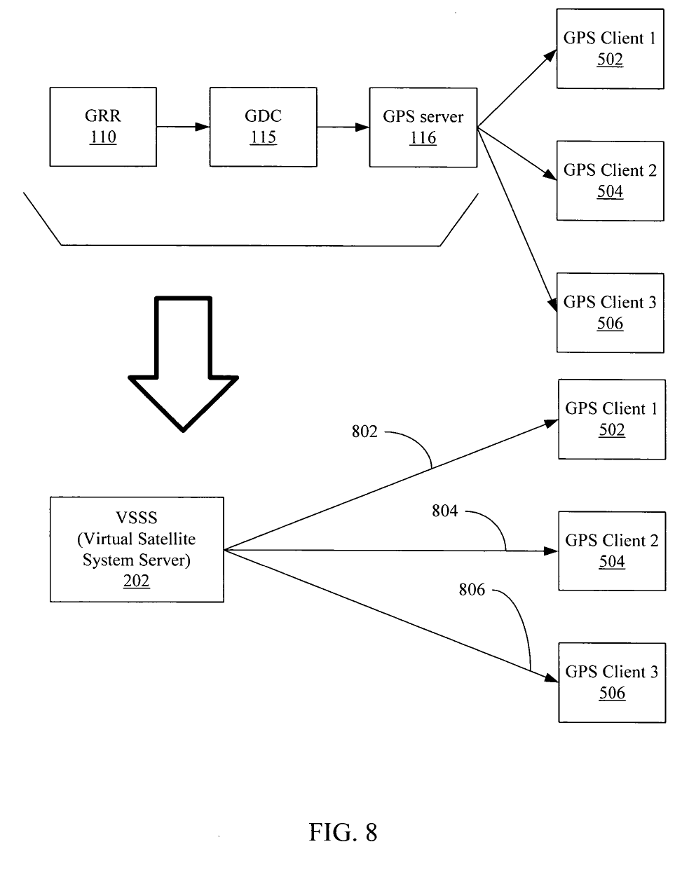

Turning to FIG. 8, a block diagram of a virtual satellite system server 602 communicating with a plurality of GPS clients 502, 504, 506. In this implementation, the virtual satellite system server 602 combines the network functionality of the GPS reference receiver 110, GPS Data Center 115 and GPS server 116 within a GPS client, such as GPS client 112, FIG. 1. The GPS server 116 is able to communicate with multiple GPS clients 502, 504 and 506. Similarly, the virtual satellite system server 602 may communicate 802, 804 and 806 with multiple GPS clients 502, 504 and 506 as opposed to point-to-point type communication of FIG. 6.

Parts of this implementation may be implemented in hardware, software, or a combination of hardware and software. Aspects of the present invention may be implemented as instructions in memory, one skilled in the art will appreciate that all or part of systems and methods consistent with the present invention may be stored on or read from other machine-readable media, for example, secondary storage devices such as hard disks, floppy disks, and CD-ROMs; a signal received from a network; or other forms of ROM or RAM either currently known or later developed.

The foregoing description of an implementation has been presented for purposes of illustration and description. It is not exhaustive and does not limit the claimed inventions to the precise form disclosed. Modifications and variations are possible in light of the above description or may be acquired from practicing the invention. For example, the described implementation includes software but the invention may be implemented as a combination of hardware and software or in hardware alone. Note also that the implementation may vary between systems. The claims and their equivalents define the scope of the invention.

1. A device having a receiver and a transmitter, comprising:
a controller;
a memory coupled to the controller; and
a virtual satellite system server capable of receipt of positioning data from the receiver and stores the positioning data in the memory where the positioning data is transmittable upon the occurrence of an event.

2. The device of claim 1, further including:
a location server that determines if the positioning data will be transmitted by the transmitter in response to the event.

3. The device of claim 1, further including the receiver in receipt of a message that contains positioning data.

4. The device of claim 2, further including a shuttle message that is composed by the controller using positioning data from the memory for transmission by the transmitter.

5. The device of claim 1, where the positioning data is at least one type of data selected from almanac, ephemeris, GPS time, DGPS data, GPS/UTC time difference, ionospheric correction.

6. The device of claim 1, where the virtual satellite server system is located in a wireless device.

7. The device of claim 1, where the virtual satellite server system is located in a network entity.

8. A method of position determination, comprising:
receiving positioning signals that contain positioning data from a satellite positioning system;
determining additional positioning data is required in order to determine position;
generating a message with positioning data that requests the additional positioning data from a virtual satellite system server; and
receiving another message that contains the additional positioning data from the virtual satellite system server that contains the additional positioning data.

9. The method of position determination of claim 8, including:
receiving a message from another virtual satellite system server that contains positioning data;
comparing the positioning data with positioning data contained in the virtual satellite system server; and
storing the positioning data in the virtual satellite system server when the message contains position data that is newer then the positioning data contained in the virtual satellite system server.

10. The method of position determination of claim 9, where storing the portion of the positioning data further includes:
storing at least one type of positioning data from positioning data types that consists of almanac, ephemeris, GPS time, DGPS data, GPS/UTC time difference, ionospheric correction.

11. An network apparatus having a transmitter and a receiver, comprising:
a controller;
a memory coupled to the controller; and
a plurality of instructions executed by the controller that result in a virtual satellite system server that stores positioning data in the memory and retrieves the positioning data from the memory in response to reception of a request at the network apparatus.

12. The network apparatus of claim 11, where the plurality of instructions further include:
another plurality of instructions executed by the controller that result in a location server that identifies if the virtual satellite system server responds to the request.

13. A device having a receiver and a transmitter, comprising:
a controller;
a memory coupled to the controller; and
a virtual satellite system server means for processing positioning data upon receipt of a message at the receiver and able to store the positioning data in the memory where the positioning data is transmittable by the virtual satellite system server means upon the occurrence of an event.

14. The device of claim 13, further including:
a location server means for determining if the positioning data will be transmitted by the transmitter in response to the event.

15. The device of claim 13, where the positioning data is at least one type of data selected from almanac, ephemeris, GPS time, DGPS data, GPS/UTC time difference, ionospheric correction.

16. The device of claim 13, where the virtual satellite server system is located in a wireless device.

17. The device of claim 13, where the virtual satellite server system is located in a network entity.

18. A machine-readable media with a plurality instructions for implementing a method of position determination, the plurality of instructions comprising instructions for:
receiving positioning signals that contain positioning data from a satellite positioning system;
determining additional positioning data is required in order to determine position;
generating a message with positioning data that requests the additional positioning data from a virtual satellite system server; and
receiving another message that contains the additional positioning data from the virtual satellite system server.

19. The machine-readable media of claim 18, including a plurality of instructions for:
receiving a message from another virtual satellite system server that contains positioning data;
comparing the positioning data with positioning data contained in the virtual satellite system server; and
storing the positioning data in the virtual satellite system server when the positioning data is newer then the positioning data contained in the virtual satellite system server.

20. The machine-readable instructions of claim 19, where the instructions for storing the positioning data further includes a plurality of instructions for:
storing at least one type of positioning data from positioning data types that consists of almanac, ephemeris, GPS time, DGPS data, GPS/UTC time difference, ionospheric correction.
